(19) United States
(12) Patent Application Publication
(10) Pub. No.: US 2010/0252373 A1
(43) Pub. Date: Oct. 7, 2010

(54) FRICTION DEVICE FOR A SPRING CYLINDER

(75) Inventors: Odd N. Oddsen, JR., Easton, PA (US); Howard M. Williams, JR., Allentown, PA (US)

Correspondence Address: DESIGN IP, P.C., 5100 W. TILGHMAN STREET, SUITE 205, ALLENTOWN, PA, 18104, US

(73) Assignee: INNOVATIVE OFFICE PRODUCTS, INC., Easton, PA (US)

(21) Appl. No.: 12/417,306

(22) Filed: Apr. 2, 2009

(51) Int. Cl. B60T 17/08; F16F 9/18

(52) U.S. Cl. 188/67; 267/124

(57) ABSTRACT

A positionable support device employs a motion restriction device retrofitted to an existing spring cylinder to adjust the amount of force exerted. In one embodiment, split ring is pressed against an actuating shaft of the spring cylinder with adjustable force. The force on the split ring causes frictional resistance to the motion of the shaft thereby reducing the force applied. This is useful in spring-loaded positioners which allow the object to be placed, and remain in a selected position. The spring cylinder may be gas-charged or spring-loaded support. Various types of friction adjustment units may be employed to result in a positionable support device which holds an object in a desired position.

### BACKGROUND OF THE INVENTION

The invention relates generally to a friction device for dampening the motion of a gas spring cylinder.

Positionable support arms for mounting electronic peripheral devices, such as computer monitors or televisions to, among other things, a wall, column, ceiling, desktop or other support structure are well known in the prior art. Conventional support arms include a rigid elongated arm having a first end pivotally coupled to the support structure for pivoting movement about a generally horizontal first pivot axis and vertically between and upper and lower position. A mounting element is provided for coupling a device to a second end of the rigid arm, which typically provides for pivoting of the device about a second generally horizontal pivot point, and vertically to maintain the orientation of the device as the arm is moved between upper and lower positions.

Some conventional support arm systems rely on frictional contact between moving parts of the rigid arm to hold a device in the desired position relative to the support structure. Such systems require that the frictional forces overcome the force of gravity acting on the support arm and the associated device. For example, the arm may include a frictional assembly at a pivot point including at least two planar surfaces where a nut, bolt and spring washer assembly provide tension to the assembly.

Other conventional support arms of the prior art include springs, gas springs, also referred to as gas cylinders or pneumatic cylinders, or other biasing means to counterbalance at least a portion of the weight of an object supported by the support arm. This enables a user to move supported objects upwardly using less force than would be required to lift the object.

In some applications it is desirable to provide a gas spring cylinder and to dampen the cylinder so that the support arm remains stationary when a user finishes moving the object being supported to a new position. Such “dampening” can be accomplished by providing additional frictional resistance on the cylinder shaft. It is also often desirable to provide means to adjust the amount of friction being exerted on the cylinder shaft, in order to accommodate different user preferences and objects of different weights. For example, U.S. Pat. No. 7,014,157, entitled “Friction Cylinder for a Support Device,” teaches a custom-built spring cylinder having a friction device located on the interior of the cylinder.

There is a need for a more cost-effective means to dampen the movement of the shaft of a gas or spring cylinder. In addition, there is a need for an improved means for adjusting the amount of friction exerted on the shaft of a gas or spring cylinder.

### SUMMARY OF THE INVENTION

In one respect, the invention comprises a positional support comprising: a shaft capable of being extended and/or retracted; a spring cylinder attached to the shaft capable of applying an urging force on the shaft pushing it toward its extended position; and a motion resistance device externally attached to the spring cylinder for applying frictional resistance to any motion of the shaft.

In another respect, the invention comprises a motion resistance device for retrofitting existing spring support having a spring cylinder that activates a shaft comprising: a frictional element in contact with the shaft for providing frictional resistance to the shaft; a collar having: a cup for enclosing and holding the frictional element against the shaft; at least one arm for attaching the collar to the spring cylinder; and friction adjustment unit for applying adjustable pressure to the frictional element.

In yet another respect, the invention comprises a motion resistance device for retrofitting existing spring supports having a spring cylinder and a shaft comprising: a wedge-shaped frictional element in contact with the shaft for providing frictional resistance to the shaft; a collar having: a threaded outer surface; a tapered recess for receiving, enclosing and holding the wedge-shaped frictional elements against the shaft; at least one arm for attaching the collar to the spring cylinder; a friction adjustment unit for applying adjustable pressure to the frictional element; and a securing device for securing the at least one arm to the spring cylinder; wherein the friction adjustment unit applies adjustable force on the frictional element causing adjustable frictional resistance to movement of the shaft.

### BRIEF DESCRIPTION OF THE DRAWINGS

The present invention will hereinafter be described in conjunction with the appended drawing figures wherein like numerals denote like elements.

FIG. 1 is a side elevational view showing the adjustable support device 30 of the present invention in use;

FIG. 2 is an exploded view showing the adjustable support device 30 of the present invention;

FIG. 3 is a perspective view showing the adjustable support device 30 of the present invention fully assembled;

FIG. 4 is an enlarged sectional view taken along line 4-4 of FIG. 3;

FIG. 5 is an exploded view showing an alternative embodiment of the adjustable support device of the present invention which is attached to a spring support;

FIG. 6 is a perspective view showing an alternative embodiment of the adjustable support device 130 of the present invention fully assembled; and

FIG. 7 is an enlarged sectional view taken along line 7-7 of FIG. 6.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

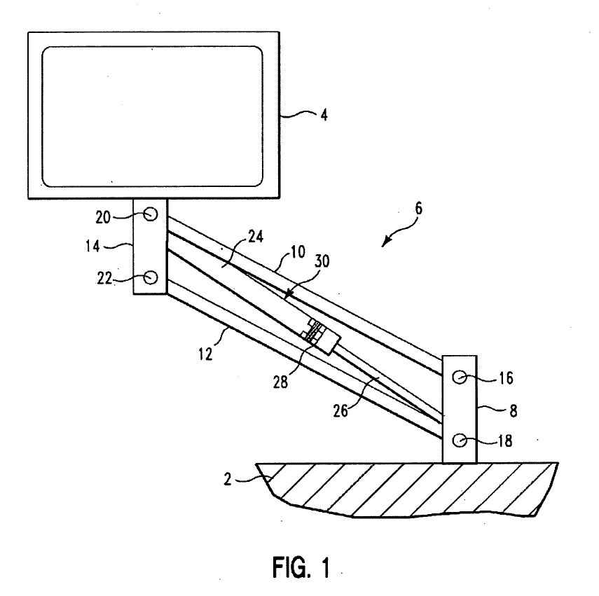

FIG. 1 is a side elevational view showing one embodiment of an adjustable support device 30 of the present invention in use as part of a positioner 6 for holding a computer monitor 4.

In this preferred embodiment, a computer monitor 4 is being supported and held at a pre-selected position by a positioner 6. Positioner 6 has a base 8, which is attached to a fixed surface 2, and mount 14, which is connected to monitor 4. A first arm 10 is pivotally connected to base 8 at a first pivot 16 and also to mount 14 at a third pivot 20. A second arm 12 is also pivotally connected to base 8 at a second pivot 18, and to mount 14 at a fourth pivot 22. First and second arms 10, 12 are intended to remain approximately parallel to each other throughout the normal range of motion of the positioner 6.

An adjustable support device 30 attaches diagonally at or near pivots 18, 20. Adjustable support device 30 includes a cylinder 24, a shaft 26 extending from the cylinder 24, and a motion resistance device 28 for resisting extension or retraction of shaft 26. The adjustable support device 30 provides a compressive force that opposes the force exerted on the positioner 6 by the weight of the monitor 4. As will be explained in greater detail herein, the motion resistance device 28 provides frictional resistance against movement of the shaft 26 and is designed to keep the monitor 4 stationary after user adjusts the position of the monitor 4 and has released it.

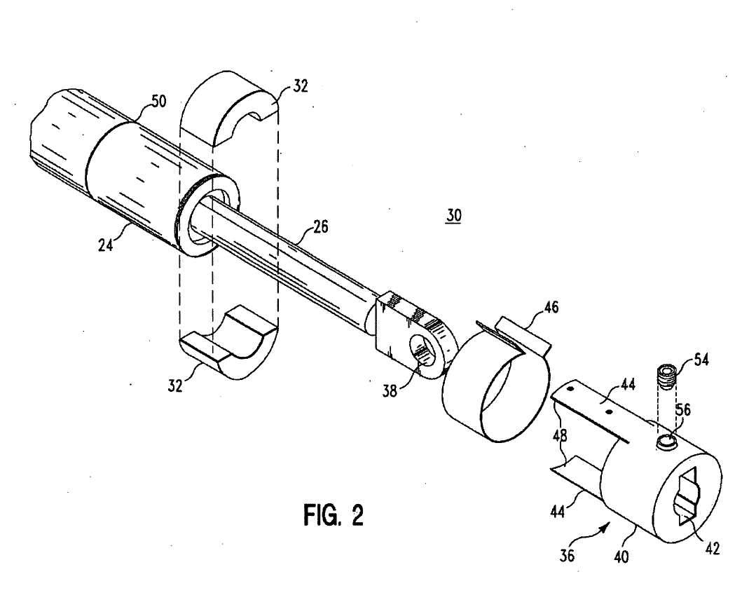

FIG. 2 is an exploded view showing the adjustable support device 30 of the present invention. In this embodiment, the adjustable support device 30 includes a standard, pre-manufactured gas cylinder, which comprises a shaft 26 that is slidably contained within a cylinder 24. The cylinder 24 includes a pressurized gas and piston arrangement (not shown) which urges the shaft 26 outwardly from the cylinder. In alternate embodiments, other means of providing a compressive force could be provided, such as a spring, for example. The shaft 26 includes an attachment end 38, which is intended to engage the pivot 18 (see FIG. 1).

In accordance with the present invention, the adjustable support device 30 also includes a motion resistance device 28, which is designed to be installed over the shaft 26 and external to the cylinder 24. This allows the motion resistance device 28 to be used with a standard gas cylinder instead of requiring a custom designed and built gas cylinder, and enables the motion resistance device 28 to be retrofitted to a standard gas cylinder.

The motion resistance device 28 comprises a split ring having two halves 32a, 32b, which are positioned on opposing sides of the shaft 26. A collar 36 encloses the split ring halves 32a, 32b and holds them in position against the shaft 26. The collar 36 includes a cylindrical cup 40, sized to slide over the split ring halves 32a, 32b and the shaft 26, and two opposing arms 44a, 44b that extend from an open end of the cup 40. Each of the arms 44a, 44b has a respective protrusion 48a, 48b that extends inwardly from the end of its respective arm 44a, 44b in a substantially perpendicular direction. The length of the arms 44a, 44b and the position and shape of the protrusions 48a, 48b are designed to engage a groove 50 of cylinder 24, which retains collar 36 in position over split ring halves 32a, 32b and onto cylinder 24. Groove 50 is provided in many standard gas cylinders.

The cup 40 also includes an opening 42, which is shaped to allow the attachment end 38 and shaft 26 pass through. Accordingly, in this embodiment, the opening 42 includes a circular-shaped center portion 41 that is positioned between opposing rectangular end portions 43a, 43b.

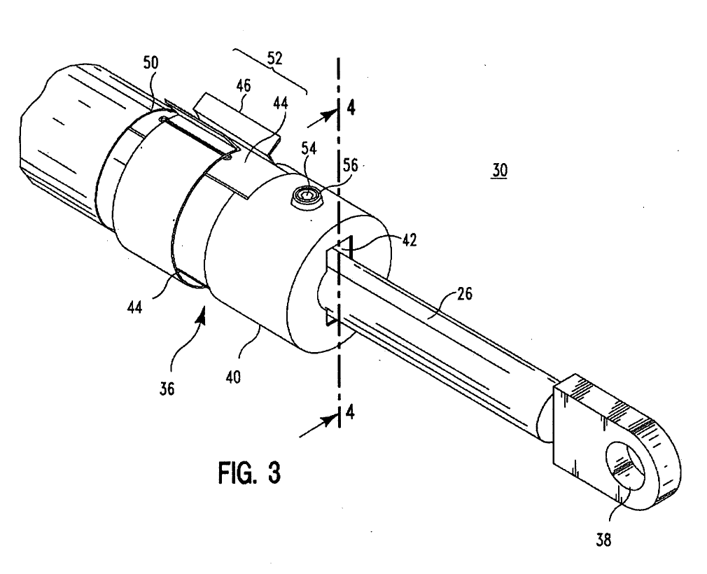

A strap 46 is preferably slid over the arms 44a, 44b, which holds the arms 44a, 44b tightly against cylinder 24, and therefore, prevents protrusions 48a, 48b from releasing from the groove 50. Arms 44a, 44b, protrusions 48a, 48b, groove 50 and strap 46 are collectively identified in FIG. 3 as a securing device 52. Other alternative means, such as screws, rivets, fittings or other fasteners, for example, could be used to secure the collar 36 to the cylinder 24.

The amount of frictional resistance that the motion resistance device 28 provides against movement of the shaft 26 is determined by the force exerted by the split ring halves 32a, 32b against the shaft 26. In order to enable the motion resistance device 28 to be used in a wide variety of applications, it is preferable that the amount of frictional resistance be adjustable. In this embodiment, the force exerted by the split ring halves 32a, 32b against the shaft 26 can be varied by adjusting a screw 54 that is threaded into a recess 56 on the side of the cup 40. As screw 54 is threaded into the recess 56, it presses split ring halves 32a, 32b more tightly against shaft 26, thereby increasing the amount of frictional resistance acting on the shaft 26.

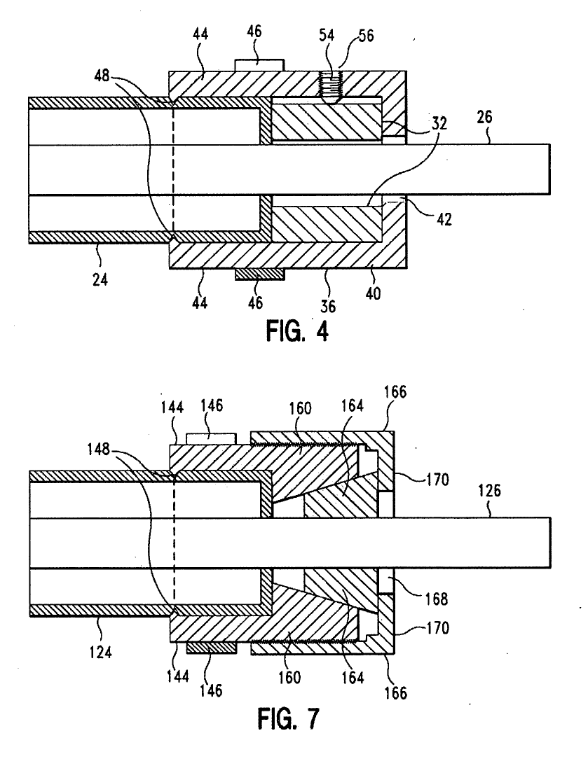

FIGS. 3 and 4 show the adjustable support device 30 of the present invention fully assembled. Arms 44a, 44b of collar 36 are held against cylinder 24 with strap 46. Cup 40 is shown here completely enclosing split ring halves 32a, 32b.

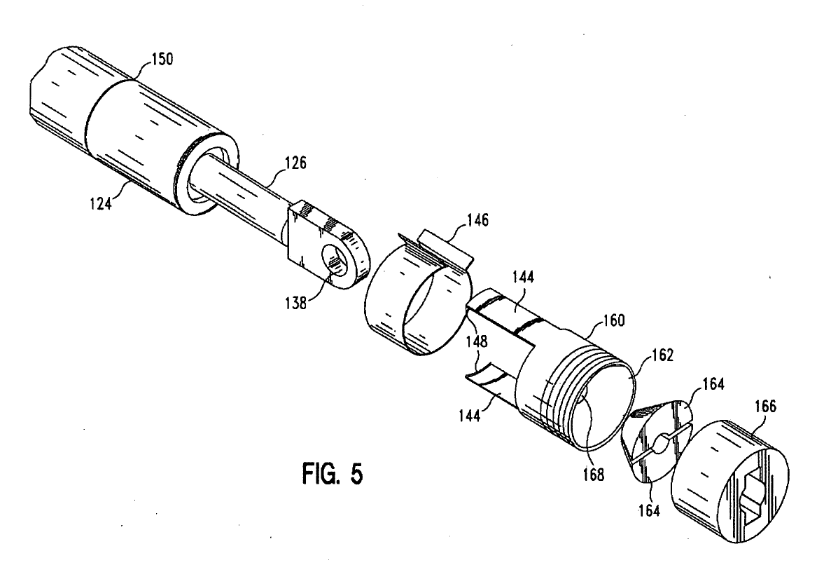

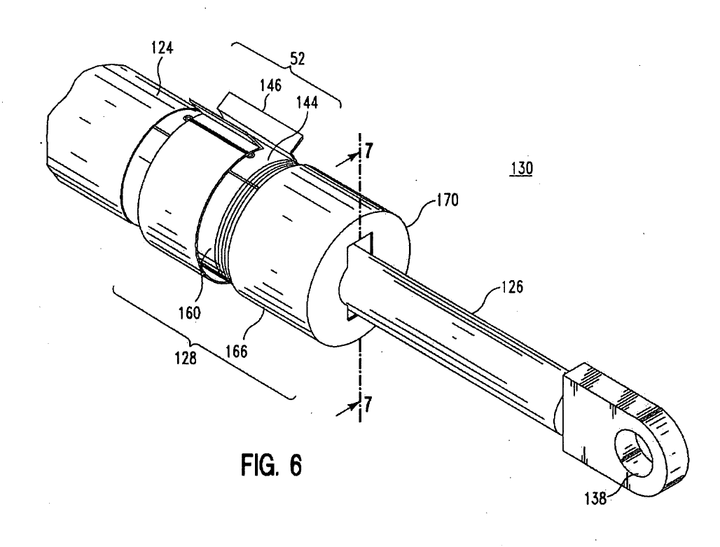

FIGS. 5 through 7 show an alternate embodiment of the adjustable support device 130 of the present invention. In this embodiment, elements shared with the first embodiment are represented by reference numerals increased by factors of 100. For example, the cylinder 24 in FIGS. 2-4 corresponds to cylinder 124 in FIGS. 5-7. Some features of this embodiment that are substantially identical to corresponding features in the first embodiment and were described with respect to the first embodiment are numbered in FIGS. 5-7 but are not specifically referred to in the specification.

As in the previous embodiment, this embodiment also employs arms 144a, 144b having protrusions 148a, 148b, which fit into groove 150 of cylinder 124, and strap 146 encircles the arms 144a, 144b and secures them to cylinder 124.

In this embodiment, a collar 136 having a threaded portion 161 and a tapered cup 140 is provided. The tapered cup 140 is of a truncated conical shape and includes a circular opening 168 sufficiently large in size to allow the passage of the shaft 126. Two tapered split ring halves 132a, 132b (also of a truncated conical shape when paired) are provided and are complimentary in shape to the tapered cup 140. A cap 166, having internal threads 163 formed thereon, is designed to thread onto the threaded portion 161 of the collar 136 and retain the split ring halves 132a, 132b around the shaft 126 and within the tapered cup 140.

In this embodiment, the amount of friction applied by the split ring halves 132a, 132b against the shaft 126 can be adjusted by tightening or loosening the cap 166 (i.e., by rotating the cap 166 clockwise or counterclockwise, respectively, relative to the collar 136). A shoulder portion 170 of the cap 166 rests against the split ring halves 132a, 132b when the cap 166 is threaded onto the collar 136. As cap 166 is tightened, the shoulder portion 170 urges the split ring halves 132a, 132b further into the tapered cup 140 (to the left in FIG. 7) which, in turn, forces the split ring halves 132a, 132b inwardly against the shaft 126. This causes an increase in frictional resistance on shaft 126, further resisting extension or retraction of shaft 126. Conversely, as cap 166 is loosened, the shoulder portion 170 moves away from the split ring halves 132a, 132b (to the right in FIG. 7), which allows the split ring halves 132a, 132b to move outwardly with respect to the tapered cup 140 and exert less force against the shaft 126. This causes a decrease in frictional resistance on shaft 126, which reduces resistance to extension or retraction of shaft 126.

While the principles of the invention have been described above in connection with preferred embodiments, it is to be clearly understood that this description is made only by way of example and not as a limitation of the scope of the invention.

1. A positional support comprising:
a shaft capable of being extended and/or retracted;
a spring cylinder attached to the shaft capable of applying an urging force on the shaft pushing it toward its extended position; and
a motion resistance device externally attached to the spring cylinder for applying frictional resistance to any motion of the shaft.

2. The positional support of claim 1, wherein the motion resistance device comprises:
a frictional element in contact with the shaft for providing frictional resistance to the shaft;
a collar adapted to enclose and hold the frictional element against the shaft;
friction adjustment unit for applying adjustable pressure to the frictional element; and
a securing device for securing the collar to the spring cylinder;
wherein the friction adjustment unit applies adjustable force between the collar and the frictional element, causing adjustable frictional resistance to movement of the shaft.

3. The positional support of claim 2 wherein the collar further comprises:
a cup for enclosing and holding the frictional element against the shaft;
at least one arm for attaching the collar to the spring cylinder.

4. The positional support of claim 3, wherein the friction adjustment unit comprises:
a threaded recess through the cup; and
a screw fitting into the threaded recess pressing the frictional element away from the collar and pressing it on the shaft.

5. The positional support of claim 3, wherein the securing device is a strap encircling the at least one arm and holding it against the spring cylinder.

6. The positional support of claim 3, wherein the securing device further comprises:
at least one groove on the spring cylinder; and
at least one protrusion on the at least one arm of the collar shaped to fit into the at least one groove of the spring cylinder.

7. A motion resistance device for retrofitting existing spring support having a spring cylinder that activates a shaft comprising:
a frictional element in contact with the shaft for providing frictional resistance to the shaft;
a collar having:
a cup for enclosing and holding the frictional element against the shaft;
at least one arm for attaching the collar to the spring cylinder; and
friction adjustment unit for applying adjustable pressure to the frictional element.

8. The motion resistance device of claim 7 wherein the friction adjustment unit comprises:
a threaded recess through the cup; and
a screw fitting into the threaded recess pressing the frictional element away from the collar and pressing it on the shaft.

9. The motion resistance device of claim 7 further comprising:
a securing device having a strap encircling the at least one arm and holding it against the spring cylinder.

10. The motion resistance device of claim 7 wherein the securing device further comprises:
at least one groove on the spring cylinder;
at least one protrusion on the at least one arm of the collar shaped to fit into the at least one groove of the spring cylinder.

11. The motion resistance device of claim 7 wherein the frictional element comprises:
a split ring.

12. A motion resistance device for retrofitting existing spring supports having a spring cylinder and a shaft comprising:
a wedge-shaped frictional element in contact with the shaft for providing frictional resistance to the shaft;
a collar having:
a threaded outer surface;
a tapered recess for receiving, enclosing and holding the wedge-shaped frictional elements against the shaft;
at least one arm for attaching the collar to the spring cylinder,
a friction adjustment unit for applying adjustable pressure to the frictional element; and
a securing device for securing the at least one arm to the spring cylinder;
wherein the friction adjustment unit applies adjustable force on the frictional element causing adjustable frictional resistance to movement of the shaft.

13. The motion resistance device of claim 12 wherein the friction adjustment unit includes a screw cap comprising:
a cylindrical shape with a curved sidewall having a threaded inner surface for interacting with the threaded outer surface of the collar;
a first end of the screw cap having an opening capable of fitting over the wedge-shaped frictional element;
a second end having a shoulder for pressing against the wedge-shaped frictional element;
wherein the screw cap is screwed onto the collar causing the wedge-shaped frictional element to press against the tapered recess causing the wedge-shaped frictional element to press against the shaft causing adjustable resistance to any motion of the shaft.

14. The motion resistance device of claim 13 wherein the screw cap further comprises:
a central aperture in the second end allowing the shaft to fit through it.

15. The motion resistance device of claim 12 further comprising:
a securing device for attaching the collar to the spring cylinder.

16. The motion resistance device of claim 12 wherein the securing device is a strap for encircling the at least one arm and holding it against the spring cylinder.

17. The motion resistance device of claim 12 wherein the securing device further comprises:
at least one groove on the spring cylinder;
at least one protrusion on the at least one arm of the collar shaped to fit into the at least one groove of the spring cylinder.
